(19) United States
(12) Patent Application Publication
(10) Pub. No.: US 2003/0103020 A1
(43) Pub. Date: Jun. 5, 2003

(54) Doll figure with user initiated audio and electro-luminescent (EL) display

(75) Inventor: Dong Wook Kim, Kowloon (HK)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: DJ Plush Toys (HK) Ltd., Mongkok (HK)

(21) Appl. No.: 10/000,225

(22) Filed: Nov. 30, 2001

(51) Int. Cl. G09G 3/30

(52) U.S. Cl. 345/76

(57) ABSTRACT

A toy caricature which presents an informational message initiated by the user. The informational message comprises a combination of a stored audio sound and a backlit display with a message. The caricature is typically a stuffed figure, which is crafted to invoke a certain look and feel. The electronic recording and playback of the audio sound is controlled by a multi function electronic IC along with a voltage pump. The unit is battery operated and constructed as a consumer item for any age group, which includes such markets as a child toy and an adult advertising collateral item.

### CROSS REFERENCE TO RELATED APPLICATIONS

This non-provisional application is based on the provisional patent application serial No. 60/______, entitled “Doll Figure User Initiated Audio and Electro-Luminescent Display” with inventor Dong Wook Kim filed Nov. 5, 2001, which is hereby incorporated by reference in its entirety.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### BACKGROUND OF THE INVENTION

1. Field of the Invention

The present invention generally relates to the field of stuffed toy dolls and more particularly, to toy dolls with prerecorded audio sound and one or more flashing lights to display messages.

2. Description of the Related Art

### SUMMARY OF THE INVENTION

Briefly in accordance with the present invention, an exemplary form of a snowman, or an animal such as a Teddy Bear is presented with battery-operated apparatus for presenting an audio and visual message. In one embodiment this message is triggered by a switch, which is packaged within the left hand or paw. Once pressed the pre-recorded audio sound is rendered along with an Electro-Luminescent (EL) Display containing a substantially compatible visual message to the audio sound. The audio and display messages once rendered are turned off and the electronic apparatus is returned to a low power state.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a drawing of a teddy bear figure with a “Happy!” message on the belly of the toy figure according to the present invention.

FIG. 2 is circuit diagram of the electronics for the teddy bear of FIG. 1, according to the present invention.

FIG. 3 is a battery holder for two AA batteries, which power the electronics of FIG. 2, according to the present invention.

FIG. 4 is a drawing of an Electro-Luminescent (EL) Frame, which is the EL Display source for backlighting the message according to the present invention.

FIG. 5 is a drawing of a EL Ring which is affixed to the EL Frame of FIG. 5, according to the present invention.

FIG. 6 is a drawing of a EL Washer which is affixed to the EL Frame of FIG. 5, according to the present invention.

FIG. 7 is an EL Holder assembly drawing of FIGS. 5-7, according to the present invention.

FIG. 8 is a bill of material listing for the electronic circuit of FIG. 2, according to the present invention.

FIG. 9 is a drawing of a sample of a visual message for the EL Display source, according to the present invention.

FIG. 10 is a drawing of a sample of a visual message for the EL Display source, according to the present invention.

FIGS. 11-12 are descriptions of the EL Display component of FIG. 2, according to the present invention.

### DETAILED DESCRIPTION OF AN EMBODIMENT

It is important to note, that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

In the drawings like numerals refer to like parts through several views.

Doll Figure

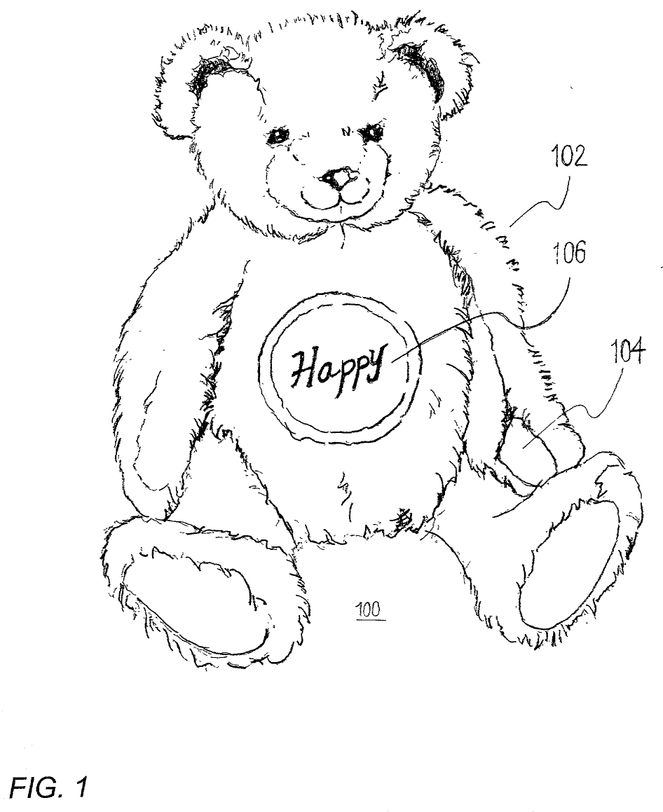

FIG. 1 is an illustration 100 of a teddy bear figure 102 with a child friendly persona, according to the present invention. There is a message screen on the belly 106. During operation, in one embodiment, a user squeezes the left paw 104. Within this paw is a normally open switch which when closed initiates the playback of a prerecorded audio sound. It is important to note that in other embodiments the switch is embedded in other areas of the bear including the right paw, the belly, the back, or the left or right foot. The prerecorded audio sound is substantially compatible with the theme or persona of the toy figure 102 and the display message 106, in this example “Happy” which is backlit by the Electro-Luminescent (EL) device.

The teddy bear figure 102 is only one example of a doll which can be used with the present invent. Other toy figures representing other objects such as animals, characters, people, objects in nature, such as a “pet rock” are within the true scope and spirit of the present invention. The exact construction of the toy doll is not important to the present invention. The toy doll may be fabricated by any synthetic or natural materials or a combination of man-made and natural materials.

The message which is back-lit by the EL display may be related to the toy figure 102 or completely independent. For example the toy figure may be a popular cartoon character such as Warner Brother's Bugs Bunny and the message is “What's Up Doc”. In an alternate embodiment, the message may be less tied to the exact character. Moreover, the backlit message may be target to a specific age group, demographics of the user and more.

Electronics

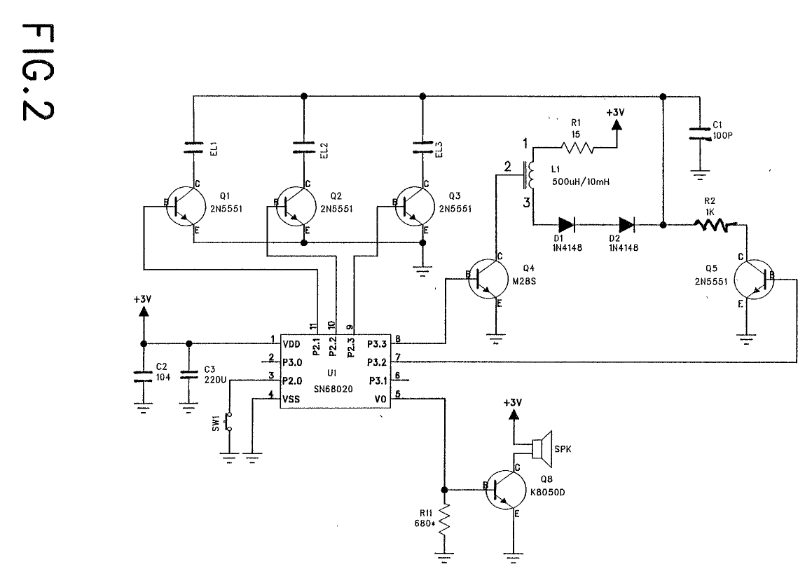

Referring to FIG. 2, circuit diagram 200, which is within the teddy bear figure 102 shows the interconnection of the audio and an Electro-Luminescent (EL) Display controller, according to the present invention. This circuit diagram has seven functional areas. They are: (1) voice record/playback IC labeled U2 210; (2) a playback timing circuit 202; (3) an Electro-Luminescent display 204; (4) an Electro-Luminescent driver 206; (5) a Voltage Pump 208; (6) a display controller labeled U1 212; and (7) a battery or power source 214. For operation SW1 is depressed which initiates the play back of the previously stored message. These are described below.

Voice Record/Playback IC-U2

The U2 is model ISD 1810 or equivalent available from Winbond 210. This device provides high-quality, single-chip, single-message, record/playback solution with user-selectable durations of 8 to 16 seconds. The CMOS device include an on-chip oscillator (with external control), microphone preamplifier, automatic gain control, anti-aliasing filter, multilevel storage array, smoothing filter, and speaker amplifier. A minimum record/playback subsystem can be configured with a microphone, a speaker, several passive components, two push buttons, and a power source. Recording is stored in on-chip nonvolatile memory cells, providing zero-power message storage. In another embodiment the recorded message is stored in a mask that is part of the IC during manufacturing. This mask programming removes the requirement of audio programming and test during the build of the electronics. The use of a mask many times is less expensive than a recordable version using nonvolatile storage.

Playback Timing Circuit

The Playback Timing Circuit 202 controls the start of the playback and the time until power down. The topology is as follows.

Transistor Q6 has its emitter grounded, its base is connected to capacitor C8 and R8 and the anode of D1, and finally its collector is connected to R4, R1 and R6 as shown. The collector of Q6 is also connected to the input of PLAYL of U2.

Transistor Q7 has its emitter grounded is connected to R1 and the anode of D2. The collector of Q7 is connected R8 R5 and R7 (as shown).

One side of switch SW1 is connected ground and the other side is connected to the RECLED output of U2, the OS input of U1 and capacitors C2, C3 and C7. U1 is model DJ3036 available from Liciti.

The operation of the timing circuit is as follows: In order to start a playback, switch SW1 is pushed which grounds the capacitors C2 and C3. This causes both transistors Q6 and Q7 to be turned off as both bases are below a threshold voltage (e.g. 0.7 volts). The two collectors of these transistors Q6 and Q7 rise to the positive voltage supply. The positive voltage of the collector of transistor Q6 is presented the to the PLAYL input of the U2 IC which causes the start of the playback. Once the capacitively coupled ground signal is completed, next the base of the transistor Q7 rises faster than the base of transistor Q8 because C8 must be charged by R8 and R5. This causes a known delay at the end of which transistor Q7 in on and as it is cross-coupled with transistor Q8 maintains an off state at transistor Q8. The resultant waveform at PLAYL is a very fast negative going waveform and a slowly rising waveform during which time the prerecorded audio sound is rendered. At the end of this transient operation transistor Q6 is off and transistor Q7 is on, maintaining a low signal at the input of PLAYL of the U2 IC.

EL—Display

The EL Displays 204 are available from Seiko Electronics. The EL Device has an operating voltage between 20-200 Volts and the frequency of 50 to 10,000 Hz. It is noted that although a typical voltage of 120 volts is generated by the electronics 200 the current demand at this voltage is very low and in the range of 0.02/cm² amps.

EL Driver

The function of this circuit is to buffer the control from the U1 IC to the EL display device. Transistors Q1, 2 and 3 206 all have their emitters grounded. The collector of transistor Q1 is connected to the display segment ELI, and the base is connected to output ELI from the display controller U1-IC 212. In a similar fashion Q2 and Q3 drive segments EL2 and 3 under the control of EL2 and 3.

Voltage Pump

The function of this circuit 208 is to generate typical 90 to 120 AC volts for the EL display. It is important to note the EL display has an operating voltage range from 20-200 Volts AC so any voltage within this range has been shown to work advantageously in the present invention. Transistor Q4 has a grounded emitter with it's base being driven by the output (labeled FSW) from the U1 IC, and the collector is connected to transformer primary side of T1. Transformer T1 has a turns ratio such that the 3 volt excursion on the primary side of the transformer results in a 120 excursion on the secondary side of the transformer. The secondary or output side of transformer T1 is connected to capacitor C6 which is used to smooth the pulsed 120 volts supplied by the secondary of transformer T1, and is used to drive the EL display. This voltage is used only during the presentation of the visual message after which transistor Q4 is tuned off maintaining a powerdown mode.

Power Source

The power source for the electronics 200 is typically a pair of batteries 214. In other embodiments a solar cell, or hand crank generator may be used.

Power Source or Battery Case A

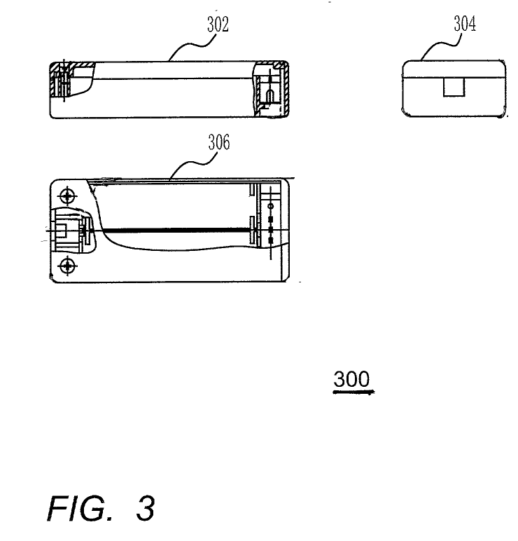

FIG. 3 shows top, bottom and side views 300 of battery holder that is used to power the electronics 200 according to the present invention. The side view 302 illustrates the bottom and top with partial cutaway views of both ends. The end view 304 shows the top being held to the bottom with a small plastic clip. The top view 306 shows a cutaway view illustrating the two locations within which the batteries are placed. It is important to note that although a battery is shown, or power sources such as DC transformers and even solar cells are within the true scope and spirit of the present invention.

Battery Case Cross Section Drawing

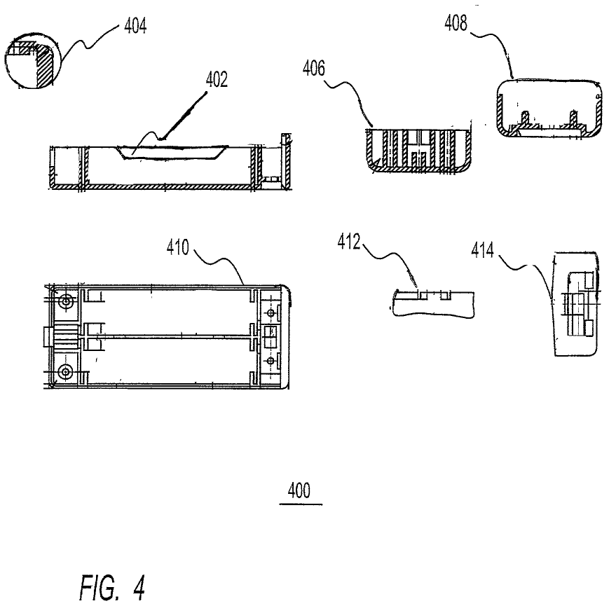

Turning now to FIG. 4 shows multiple views 400 of cross sections of a AA size battery holder 300 of FIG. 3, which are used to power the electronics 200 in the present invention. Cross section 402 illustrates the side view of the holder with ribbing to allow for the spring-loaded battery clips. Detail view 404 illustrates a notch in the top edge of the battery holder that is designed to accept the top of the battery compartment and will not allow the battery holder to swell and for the batteries to fall out. View 406 is a cross sectional view of the ribbing which stiffens the battery compartment. View 408 is a cross sectional view of the other end of the battery compartment with the battery clips which contact the battery. The top view cross sectional view 410 illustrates the location and placement of the batteries and the end contacts. Detailed view 412 is the end of the battery compartment, which contains two plastic points, which are to hold the battery compartment in place. Detail view 414 contains a view of the battery compartment with the lid in place and the plastic clip engaged so as to not slide off the battery compartment.

EL Display Holder

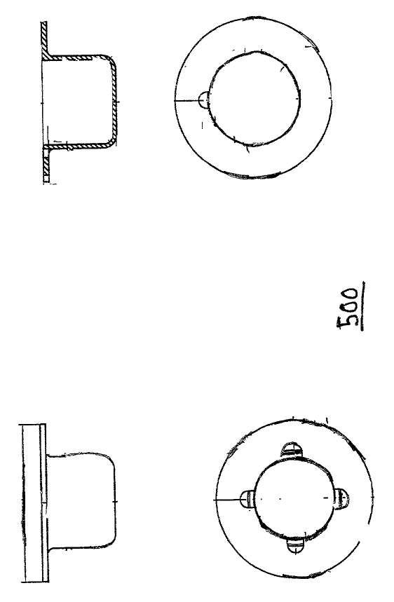

Turning now to FIG. 5, which contains multi views 500 of the top, side, bottom and sectional views of the EL display holder for holding the EL device which is driven by the electronics 200 and affixed to the toy figure 100 according to the present invention. The EL Display Holder 500 is a housing for the EL Displays EL1, EL2, and EL3 of circuit 200. The EL Display Holder 500 with the EL displays provides back-lighting to a message 106 disposed on the top of the holder which is shown as “Happy” in FIG. 1. The EL Display (EL1, EL2, EL2) provides backlit illumination during the rendering of the audio sound under the control of the electronics 200. The side view 502 illustrates that the device is in the U-shaped. The top view 504 shows the locating notch 506 for proper orientation. In addition there are four plastic studs 508 which are used during assembly. The bottom view 510 illustrates the electrical connections tabs 512. Finally the cross sectional view 514 illustrates the hollow nature of the device.

EL Ring for Display Holder

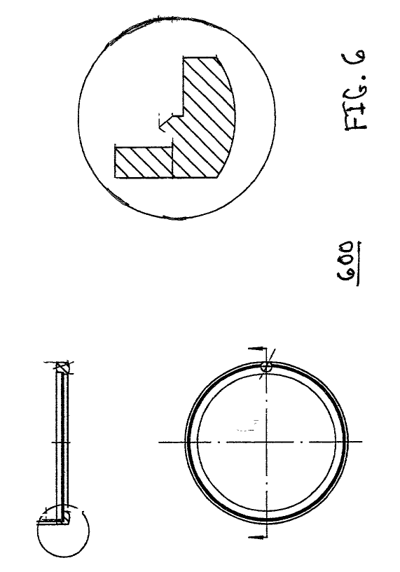

FIG. 6 shows mechanical views 600 of the EL Ring, which is used in the assembly of the backlit EL Display Holder 500 of the present invention. The top view 602 illustrates the EL ring with locating notch 604. The side view 606 shows the thickness of the ring and the small circle shows a detailed view call out 608. The side view detail callout view 610 illustrates the cross section of the ring.

EL Washer for Display Holder

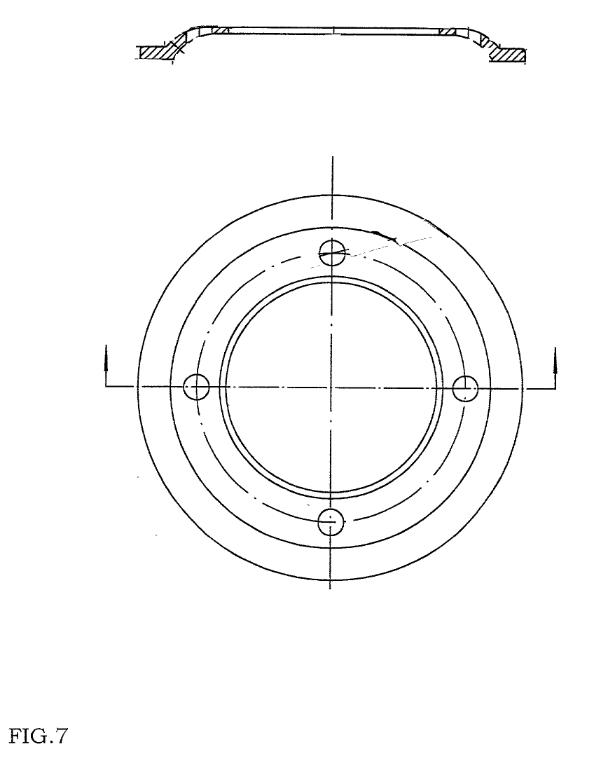

FIG. 7 shows mechanical views 700 of an EL washer, which is used in the assembly of the backlit EL Display Holder 500 of the present invention. The side view 702 illustrates the profile of the washer. The top view 704 illustrates the ring and it is noted that there is no locator notch or pin.

EL Assembly of Display Holder

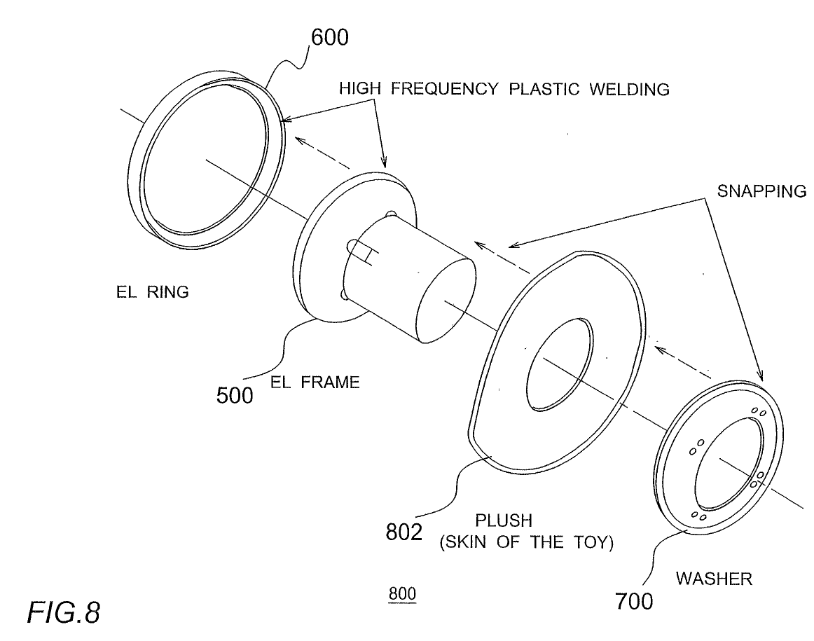

FIG. 8 illustrates an assembly drawing 800. The EL Ring 600 is affixed to the EL Frame 500 using a high frequency plastic wending method. Once positioned through the fabric 802 of the toy figure or doll the EL Washer is 700 snapped onto the EL Frame 500 permanently fixing the back lit display to the doll 100 according to the present invention.

Bill of Material of Electronic Circuit

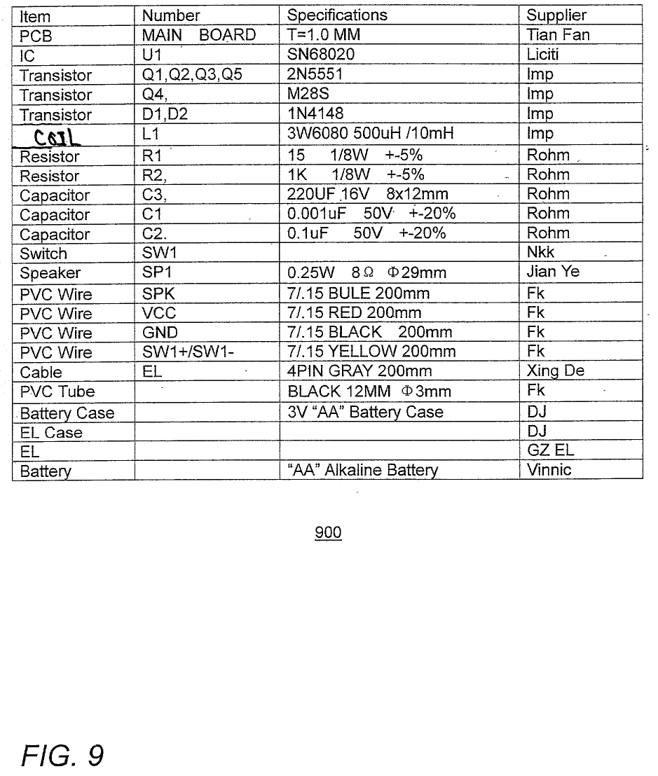

Turning now to FIG. 9 listed in table 900 are all of the parts used for assembling the circuit 200 according to the present invention.

Exemplary Visual Message

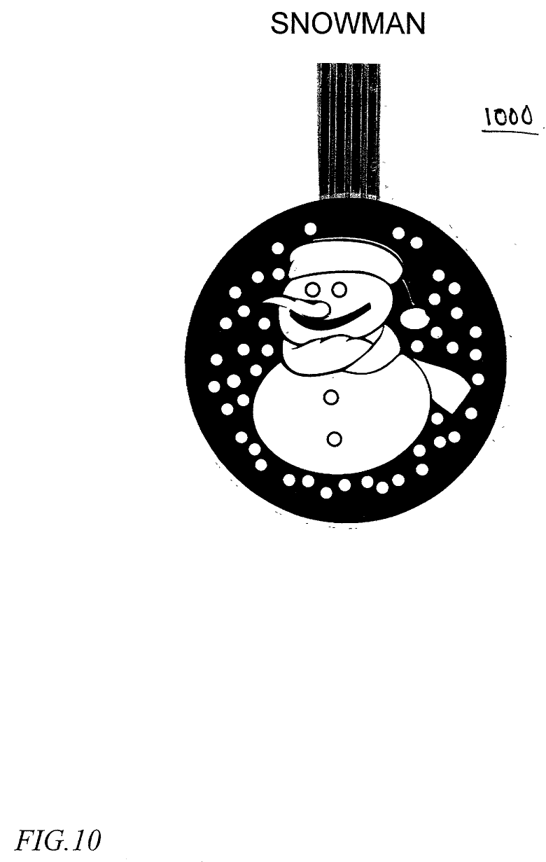

FIG. 10 shows an example of an image 1000 that is backlit according to the present invention. In an alternate embodiment of the present invention the doll is made in the shape of a snowman. An appropriate visual message would be a snowman. When this image is backlit during the rendering of the pre-stored audio sound an audio sound or song may be rendered conveying a combined seasonal theme.

SEIKO EL Display Electrical Information

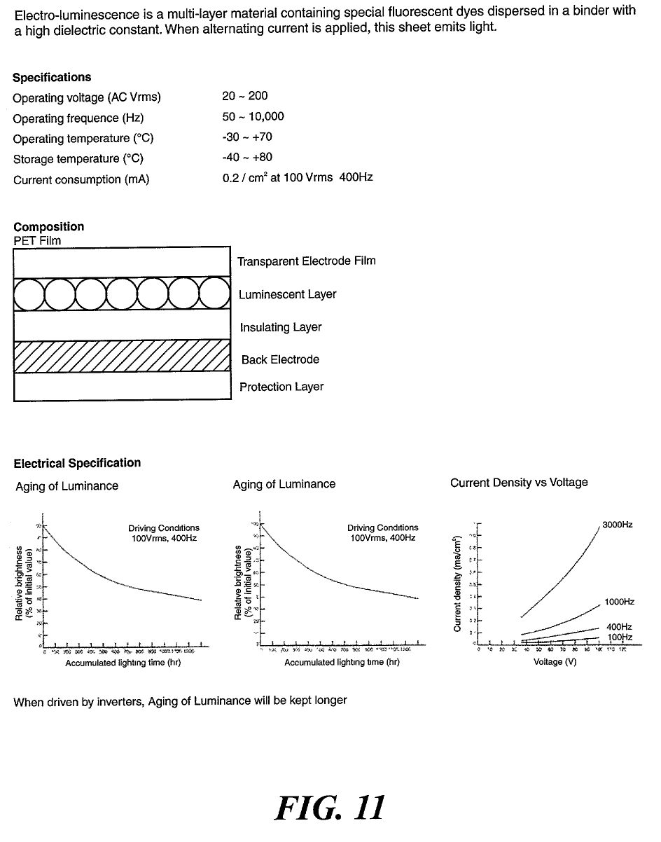

FIG. 11 contains the first page of an electrical description of the SEIKO EL device 1100, which is used in the present invention. Described is the operating voltages 20-200 and the frequency of 50 to 10,000 Hz. It is noted that although a typical voltage of 120 volts is generated by the electronics 200 the current demand at this voltage is very low and in the range of 0.02/cm² amps.

SEIKO EL Display Mechnical Information

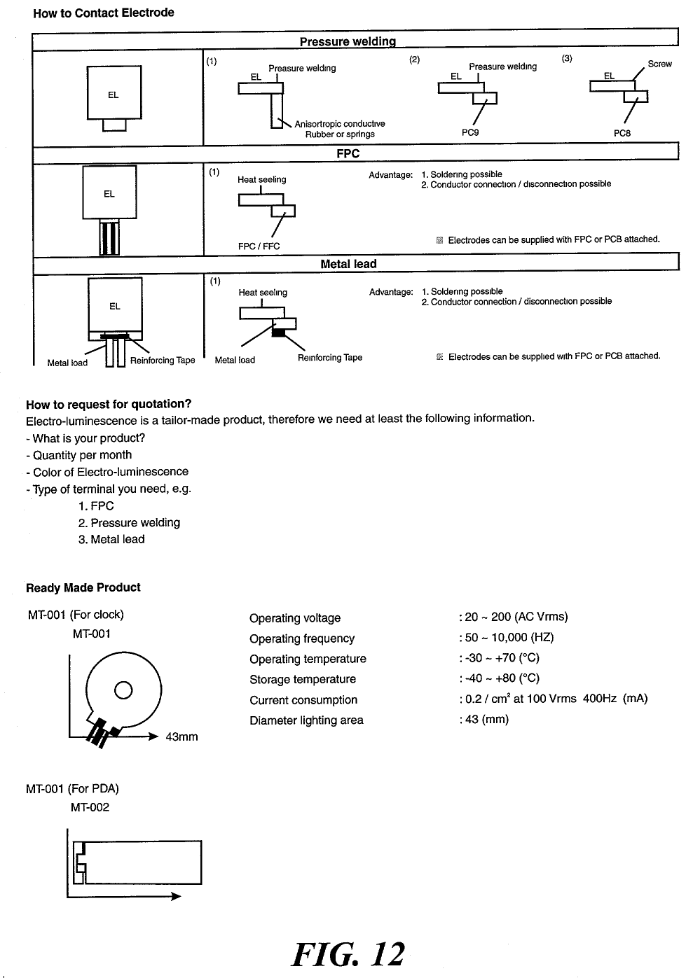

FIG. 12 illustrates the manufacturing and connection information 1200 for use in the present invention. The SEIKO Electro-Luminescent device is shown by example and the intention is for a custom size to be used in the present invention.

Non-Limiting Examples Shown

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. An Electro-Luminescent (EL) control circuit for a toy figure comprising:
an Electro-Luminescent (EL) display having one or more display segments with a message disposed thereon;
a speaker;
a voltage pump for generating a high voltage signal from a low voltage battery source, wherein the high voltage signal is in the operating range of the EL display;
a set of electronics for producing an audio signal to the speaker and illumination control signal to control the application of the high voltage signal to illuminate the one or more display elements; and
an interface to a battery for powering the set of electronics and the voltage pump.

2. The Electro-Luminescent (EL) control circuit according to claim 1, further comprising:
a switch electronically connected with the set of electronics for initiating the set of electronics to play a sound through the speaker and to illuminate the one or more display elements.

3. The Electro-Luminescent (EL) control circuit according to claim 1, wherein the set of electronics comprises:
an EL display driver circuit;
a set of EL driving transistors which along with the EL driver circuit produces the control signal for illuminating the one or more display elements; and
a timing circuit with produces a timing signal for the set of electronics so as to produce the audio signal and the illumination control signal for a predetermined period of time.

4. The Electro-Luminescent (EL) control circuit according to claim 1, wherein the high voltage signal is 20 volts or higher.

5. The Electro-Luminescent (EL) control circuit according to claim 1, wherein the an Electro-Luminescent (EL) display is a backlit display with a message disposed thereon so that the message thematically corresponds to an audio sound produced by the audio signal being applied to the speaker.

6. The Electro-Luminescent (EL) control circuit according to claim 1, wherein the set of electronics includes a model ISD 1810 IC from Windbond.

7. The Electro-Luminescent (EL) control circuit according to claim 1, wherein the set of electronics includes a model DJ3036 IC from Liciti.

8. The Electro-Luminescent (EL) control circuit according to claim 1, wherein the EL display is a Seiko Electronics brand EL display.

9. The Electro-Luminescent (EL) control circuit according to claim 2, wherein the EL driver includes one or more transistors each controlling one or more display elements of the EL Display.

10. The Electro-Luminescent (EL) control circuit according to claim 7, wherein the voltage pump includes a transformer with a turns ratio and a primary side and a secondary side, so that a battery voltage level applied to the primary side produces the high voltage signal on the secondary side capable of illuminating the one or more display elements of the EL display.

11. The Electro-Luminescent (EL) control circuit according to claim 1, wherein the set of electronics includes:
a playback device with a digital to analog converter for producing an audio signal from a stored audio sequence; and
a non-volatile storage device for storing an audio sequence so as to produce the audio signal through the playback device.

12. A circuit for driving one or more Electro-Luminescent (EL) display segments from a low voltage source, the circuit comprising:
one or more Electro-Luminescent (EL) display segments;
a voltage pump for generating a high voltage signal from a low voltage source, wherein the high voltage source is in the operating range of illuminating one or more Electro-Luminescent (EL) display segments, wherein the voltage pump includes a transformer with a turns ratio and a primary side and a secondary side, so that a low voltage level applied to the primary side produces the high voltage signal on the secondary side capable of illuminating the one or more display elements of the EL display; and
a set of electronics for producing a control signal to control the application of the high voltage signal to the one or more EL display segments, wherein the set of electronics include:
an EL display driver circuit;
a set of EL driving transistors which along with the EL driver circuit produces the control signal for illuminating the one or more display elements; and
a timing circuit with produces a timing signal for the set of electronics so as to produce the audio signal and the illumination control signal for a predetermined period of time.

13. The circuit for driving one or more Electro-Luminescent (EL) display segments, according to claim 12, wherein the set of electronics include electronics for producing an audio signal to a speaker comprising
a playback device with a digital to analog converter for producing an audio signal from a stored audio sequence; and
a non-volatile storage device for storing an audio sequence so as to produce the audio signal through the playback device.

14. The Electro-Luminescent (EL) control circuit according to claim 12, further comprising:
a switch electronically connected with the set of electronics for initiating the set of electronics to play a sound through the speaker and to illuminate the one or more display elements.

15. The Electro-Luminescent (EL) control circuit according to claim 14, further comprising:
a toy figure wherein the electronics are placed within the toy figure and the one or more EL display segments are placed within a housing which forms an opening in a surface of the toy figure so the one or more display segments are visible to an observer of the toy figure when the one or more EL display segments are illuminated.

16. The Electro-Luminescent (EL) control circuit according to claim 15, wherein the EL display segments have a message disposed thereon so that the message is backlit by the EL display segments.

17. The Electro-Luminescent (EL) control circuit according to claim 16, wherein the one or more EL display segments have a message disposed thereon so that the message is backlit when the one or more the EL display segments are illuminated.

18. The Electro-Luminescent (EL) control circuit according to claim 16, wherein the high voltage signal is 20 volts or higher.

19. The Electro-Luminescent (EL) control circuit according to claim 16, wherein the voltage pump includes an interface to a low voltage source comprises at least one of a battery and a solar cell.
